(19) United States
(12) Patent Application Publication
(10) Pub. No.: US 2011/0170689 A1
(43) Pub. Date: Jul. 14, 2011

(54) TERMINAL AND METHOD FOR PROCESSING ENCRYPTED MESSAGE

(75) Inventors: Joonkyu PARK, Seongnam-si (KR); Hyoung Sang Park, Seodaemun-gu (KR); Choong Beom You, Seoul (KR); Sung Joong Cho, Gunpo-si (KR); Hong Suk Choi, Goyang-si (KR)

(73) Assignee: Pantech Co., Ltd., Seoul (KR)

(21) Appl. No.: 12/835,879

(22) Filed: Jul. 14, 2010

(30) Foreign Application Priority Data
Jan. 14, 2010 (KR) 10-2010-0003333

(51) Int. Cl. H04K 1/00

(52) U.S. Cl. 380/247

(57) ABSTRACT

A terminal may include a memory to store first encryption information applied to the handheld terminal and second encryption information corresponding to a phone number of another party's terminal, and a control unit to encrypt a message using the first encryption information and the second encryption information stored in the memory, when transmitting the message to the other party's terminal.

### CROSS-REFERENCE TO RELATED APPLICATION

This application claims priority from and the benefit of Korean Patent Application No. 10-2010-0003333, filed on Jan. 14, 2010, which is hereby incorporated by reference for all purposes as if fully set forth herein.

### BACKGROUND

1. Field

Exemplary embodiments of the present invention relate to a handheld terminal and a method for processing a message in a handheld terminal.

2. Discussion of the Background

Along with commercialization of mobile phones, official business or personal business has been increasingly conducted through the mobile phones rather than through a direct meeting. Because of the recent increase of privacy infringement cases, such as intercepting calls, messages, and the like using an illegally duplicated mobile phone and the like, privacy protection may be needed.

In this regard, there is a need for a method of protecting personal information transmitted/received between individuals, such as with a short message service/multimedia messaging service (SMS/MMS) by improving an existing information protection function.

A variety of conventional methods that may process an encryption message using a specific encryption key or a specific server have been suggested.

Specifically, as a first example of a conventional encryption message processing method, an encryption key agreed upon in advance between a user and another party may be determined to process the encryption message. In this case, when receiving the encryption message, a receiving party should directly input the agreed upon encryption key to view a corresponding encryption message.

As a second example of a conventional method, a specific Electronic Serial Number (ESN) is inserted and transmitted using an encryption method similar to the first example, and a decoding operation of a message may be performed only in a specific location (for example, company building, etc.), which may be determined using a Global Positioning System (GPS).

As a third example of a conventional method, a separate server for providing encryption message services may be provided. In this case, a terminal may need to be connected to the specific server when receiving an encrypted message as well as when desiring to encrypt the message, and thereby a message changed using an encryption key may be received. In this instance, even though a plurality of transmission terminals encrypt and transmit the message using their own encryption keys, a reception terminal may decode the message using a single key.

As a fourth example of a conventional method, a message may be transmitted at a specific time having been registered in advance by a user, and more specifically, an encryption message having been stored in a specific server may be transmitted at a specific time in a predetermined encryption method.

However, in a case where the agreed upon encryption key is used from among the above examples of conventional methods, the encryption key may be leaked between users or between terminals, and a corresponding message may be decrypted due to the leakage of the encryption key or an illegal duplication of a terminal.

Also, in a case where the specific server is used, a conventional encryption message processing method may not prevent information leakage by the server, and thus there is a possibility that the illegally duplicated mobile phone may receive the encryption message to decode the received encryption message.

### SUMMARY

Exemplary embodiments of the present invention provide a terminal and a method for processing an encryption message in the terminal, which may process an encryption message using both first encryption information applied to a terminal of a user and second encryption information applied to a second terminal.

Additional features of the invention will be set forth in the description which follows, and in part will be apparent from the description, or may be learned by practice of the invention.

An exemplary embodiment provides a terminal, including: a memory to store first encryption information applied to the terminal and second encryption information corresponding to a phone number of a second terminal; and a control unit to encrypt a message using the first encryption information and the second encryption information stored in the memory, and to transmit the encrypted message to the second terminal.

An exemplary embodiment provides a method for processing an encrypted message of a terminal, the method including: generating first encryption information of the terminal; storing, as second encryption information, encryption information received from a second terminal, the second encryption information corresponding to a phone number of the second terminal; encrypting a message using the first encryption information and the second encryption information; and transmitting the encrypted message to the second terminal.

An exemplary embodiment provides a method for processing an encrypted message of a terminal, the method including: generating first encryption information of the terminal; storing, as second encryption information, encryption information received from a second terminal, the second encryption information corresponding to a phone number of the second terminal; receiving a message from the second terminal; determining whether the received message is an encrypted message; decoding the received message using the first encryption information and the second encryption information if the received message is encrypted; and displaying the decoded message.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a handheld terminal according to an exemplary embodiment.

FIG. 2 illustrates a method for processing an encryption message according to an exemplary embodiment.

FIG. 3 illustrates a message transmission processing unit and a message reception processing unit of FIG. 1.

FIG. 4A, FIG. 4B, and FIG. 4C illustrate examples of a screen provided by a message creation unit of FIG. 3.

FIG. 5 illustrates a structure of a message used for processing an encryption message according to an exemplary embodiment.

FIG. 6A and FIG. 6B illustrate examples of a screen provided by a message display unit of FIG. 3.

FIG. 7 illustrates an operation of an encryption information management unit of FIG. 1.

FIG. 8 illustrates an operation of a message transmission processing unit of FIG. 3.

FIG. 9 illustrates an operation of a message reception processing unit of FIG. 3.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

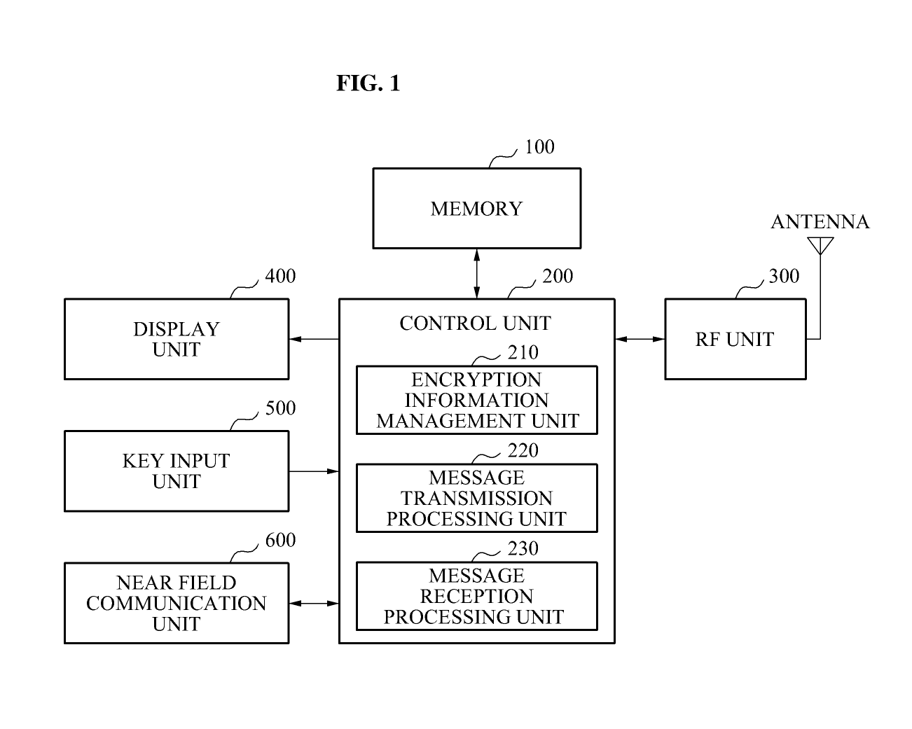

FIG. 1 illustrates a handheld terminal according to an exemplary embodiment. Referring to FIG. 1, the handheld terminal includes a memory 100, a control unit 200, a radio frequency (RF) unit 300, a display unit 400, a key input unit 500, and a near field communication unit 600.

The memory 100 may include a Read Only Memory (ROM), a flash memory, a Random Access Memory (RAM), and the like, and may store a program and reference data used for processing and controlling operations of the control unit 200.

In particular, the memory 100 may store first encryption information applied to the handheld terminal and second encryption information corresponding to a phone number of another party's terminal. In this instance, the first encryption information may be any one of an encryption key used for encrypting a message and information indicating an encryption method.

The first encryption information may be applied during a manufacturing process of the handheld terminal, or applied from a specific server when driving or booting the handheld terminal. Specifically, the first encryption information may be inputted by a user, or randomly applied by an embedded chip or by a specific code upon an initial booting. Also, the first encryption information may be implemented regardless of a specific code of the terminal (specifically, serial number, International Mobile Equipment Identity (IMEI), Electronic Serial Number (ESN), and the like).

Also, the second encryption information may be the first encryption information of the other party's terminal. Specifically, the second information may be the first encryption information received from the other party's terminal or the specific server (for example, an Application Store, an SMS server, etc.).

The control unit 200 may perform a communication control and a service control of the handheld terminal in conjunction with one of the memory 100, the RF unit 300, the display unit 400, the key input unit 500, and a near field communication unit 600.

In particular, the control unit 200 may include an encryption information management unit 210, a message transmission processing unit 220, and a message reception processing unit 230. Thus, when transmitting a message to the other party's terminal, the control unit 200 may encrypt the message using the first encryption information stored in the memory 100 and the second encryption information, which may or may not be stored in the memory 100. Also, when receiving the encrypted message from the other party's terminal, the control unit 200 may decode the received encrypted message using the second encryption information corresponding to the phone number of the other party's terminal and the first encryption information stored in the memory 100.

The encryption information management unit 210 may transmit, to the other party's terminal, the first encryption information stored in the memory 100 in response to a user's request, and store the received second encryption information in the memory 100 to enable the second encryption information to correspond to the phone number of the other party's terminal when receiving the second encryption information from the other party's terminal.

The message transmission processing unit 200 may encrypt a message created by the user using the first encryption information stored in the memory 100 and the second encryption information, and transmit the encrypted message.

When receiving the encrypted message from the other party's terminal, the message reception processing unit 230 may decode and output the received encryption message using the first encryption information from among the encryption information stored in the memory 100 and the second encryption information corresponding to the phone number of the other party's terminal.

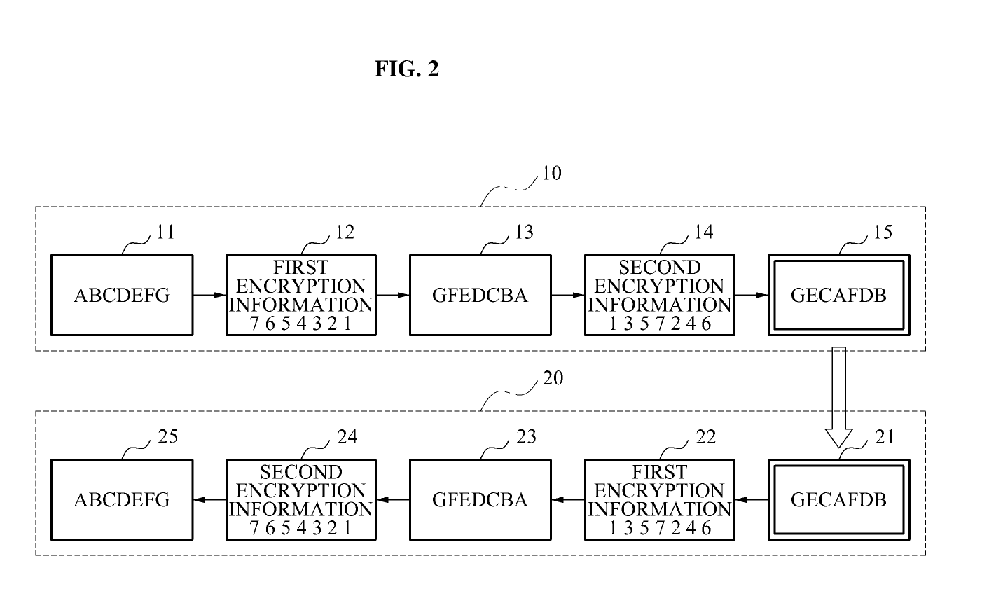

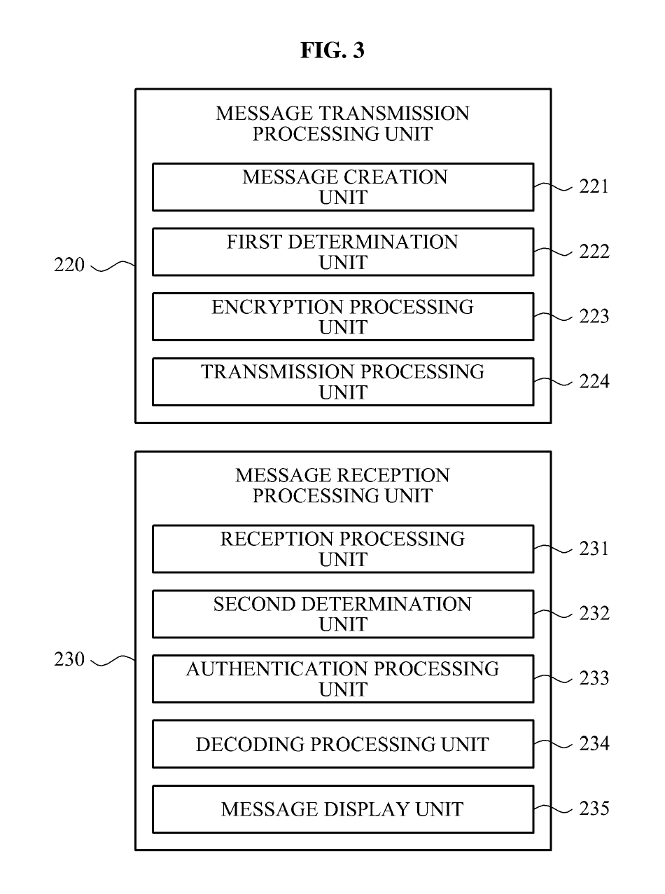

FIG. 2 illustrates a method for processing an encryption message according to an exemplary embodiment. In this instance, as illustrated in FIG. 2, a message may be processed by the message transmission processing unit 220 and by the message reception processing unit 230 similar to as described with respect to FIG. 1. Referring to FIG. 2, after a first terminal 10 encrypts an original message 11 to be an encrypted message 15, the encrypted message 15 may be transmitted to a second terminal 20. Specifically, the message transmission processing unit 220 of the first terminal 10 may encrypt the original message 11 to be an intermediate encrypted message 13, created in response to a user's request, using first encryption information 12 stored in the memory 100.

The message transmission processing unit 220 may encrypt again the intermediate encrypted message 13 to be the encrypted message 15, using second encryption information 14 corresponding to a reception phone number of the encryption message 13, and transmit, to the second terminal 20, the second encrypted message 15.

The second terminal 20 may receive the message 21 corresponding to the encrypted message 15 of the first terminal. A message reception processing unit (not illustrated) of the second terminal 20 may decode the encrypted received message 21 to an intermediate decoded message 23 using the first encryption information 22 having been stored in the memory for the second terminal 20.

Thereafter, the message reception processing unit of the second terminal 20 may decode the intermediate decoded message 23 to be a decoded message 25 using second encryption information 24 corresponding to a transmission phone number of the terminal 10.

Accordingly, the decoded message 25 finally decoded by the second terminal 20 may be the same as that of the original message 11 before being encrypted.

Here, the message transmission processing unit 220 may sequentially encrypt the original message 11 using the first encryption information 12 and the second encryption information 14, respectively; however, the message transmission processing unit 220 may perform a single encryption process using a combination of the first encryption information 12 and the second encryption information 14.

In addition, the message reception processing unit 230 may further perform a predetermined authentication process before decoding messages (for example, the received encoded message 21 or the intermediate decoded message 23).

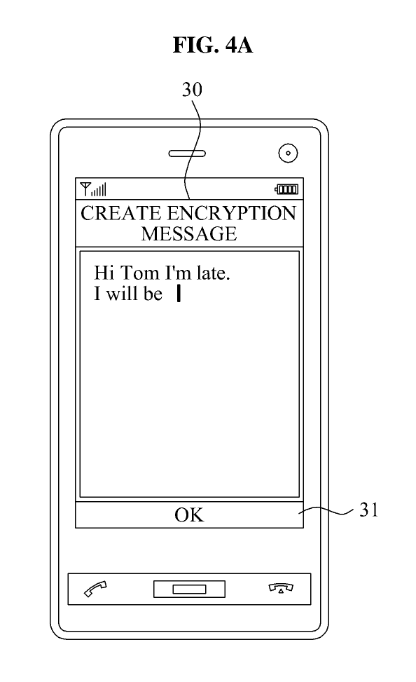

FIG. 3 illustrates the message transmission processing unit 220 and the message reception processing unit 230 of FIG. 1. Referring to FIG. 3, the message transmission processing unit 220 may include a message creation unit 221, a first determination unit 222, an encryption processing unit 223, and a transmission processing unit 224.

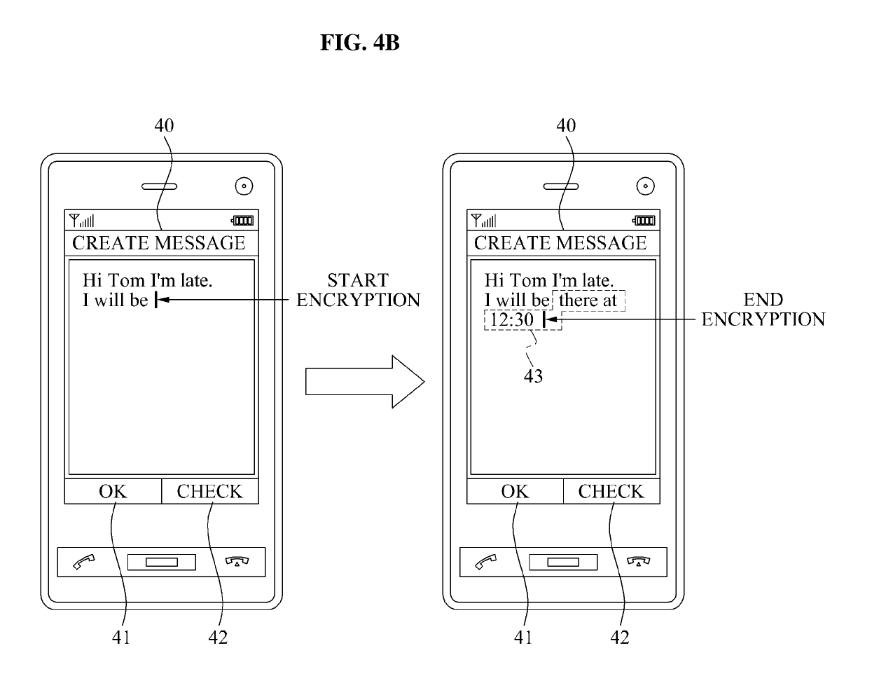

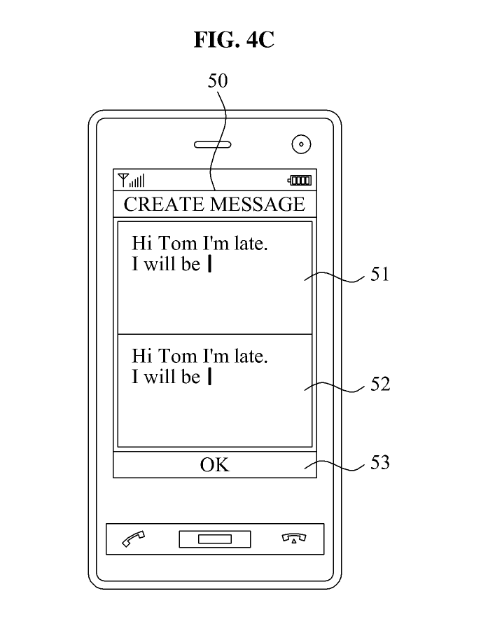

The message creation unit 221 may create a message in response to a user's request and/or input. In this instance, the message creation unit 221 may provide a screen (for example, any one of a screen 30 illustrated in FIG. 4A, a screen 40 illustrated in FIG. 4B, and a screen 50 illustrated in FIG. 4C) used for inputting a message in conjunction with a display unit 400, and configure and generate a message inputted by a user, together with an inputted reception phone number.

The screen 30 of FIG. 4A may be a screen shown when inputting a single encryption message by a user, and include a region where the message to be encrypted is inputted and an ‘OK’ button 31.

Also, the screen 40 of FIG. 4B may be a screen shown when inputting, from a user, a message of which a portion 43 is to be encrypted, and may include a ‘CHECK’ button 42 used to divide the portion 43 to be encrypted is inputted and remaining portions and an ‘OK’ button 41 used to perform an input command.

Also, the screen 50 of FIG. 4C may be a screen shown when separately inputting, from a user, a general message and a message to be encrypted, and may include a first region 51 in which a general message is inputted, a second region 52 in which the message to be encrypted is inputted, and an ‘OK’ button 53.

Referring back to FIG. 3, the first determination unit 222 may determine whether a message created by the message creation unit 221 is an encryption message, i.e., a message to be encrypted. In particular, the first determination unit 222 may provide a pop-up window or a button to command a creation of the encryption message before or after a message is created in the screens 30, 40, and 50, and determine whether to create the encryption message.

If the created message is the encryption message based on the determined result of the first determination unit 222, the encryption processing unit 223 may encrypt the message created in the screens 30, 40, and 50 using the first encryption information 12 and the second encryption information 14 corresponding to a reception phone number of the message.

In particular, if each of the first encryption information 12 and the second encryption information 14 is used as information including an encryption key, the encryption processing unit 223 may be implemented by one of a method for mixing contents of the message using the encryption key, a method for compressing the message, a method for replacing the message with another character string, and a method for adding another character or code to the message.

Also, if each of the first encryption information 12 and the second encryption information 14 is information indicating an encryption method, the encryption processing unit 223 may encrypt the message in a method corresponding to the encryption method.

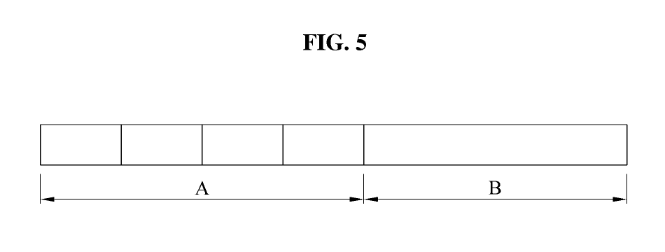

In addition, if another message (for example, a separately inputted general message, or a message of another portion) inputted by the message creation unit 221 is present, the transmission processing unit 224 may configure the other message together with the encryption message, and transmit, to a terminal indicated by the reception phone number, the configured message. Also, the transmission processing unit 224 may configure a configuration of the message to be transmitted as illustrated in FIG. 5.

FIG. 5 illustrates a structure of a message used for processing an encryption message according to an exemplary embodiment. Referring to FIG. 5, the message to be transmitted may include a header portion A and a data portion B.

The header portion A may be a portion in which a reception phone number designated by a user, a transmission phone number of a terminal, and header information indicating whether to encrypt a message are inserted.

The data portion B may be a portion where an encryption message inputted by the message creation unit 221 and a general message are inserted.

Referring back to FIG. 3, the message reception processing unit 230 may include a reception processing unit 231, a second determination unit 232, an authentication processing unit 233, a decoding processing unit 234, and a message display unit 235.

The reception processing unit 231 may receive an arbitrary encryption message from another party's terminal having an arbitrary transmission phone number.

The second determination unit 232 may determine whether the message received by the reception processing unit 231 is an encryption message.

When the received message is the encryption message based on the determined result of the second determination unit 232, the authentication processing unit 233 may perform a series of authentication processes with respect to a user (for example, inputting a user selected password or a social security number for authentication, etc.) to determine whether the authentication process succeeds.

In this instance, the authentication process may be implemented by at least one of an authentication method using a retinal scan, an authentication method using a facial recognition, an authentication method using a fingerprint recognition, an authentication method using a password or a security code, and an authentication method using a specific server for the authentication.

If the authentication process of the authentication processing unit 233 succeeds, the decoding processing unit 234 may decode the received message using first information stored in the memory 100 and second encryption information corresponding to the transmission phone number.

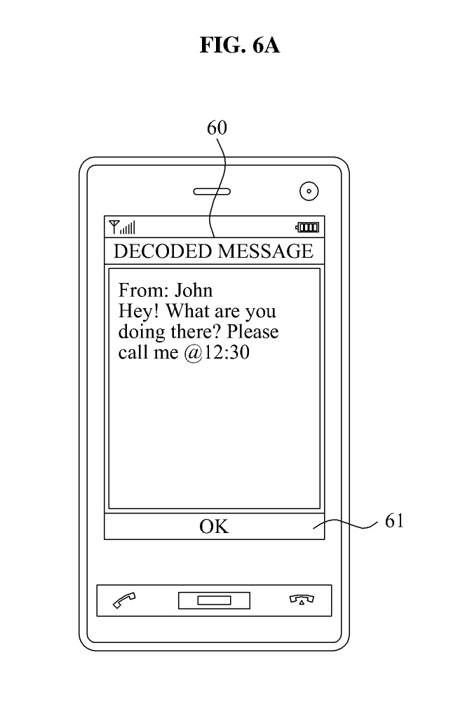

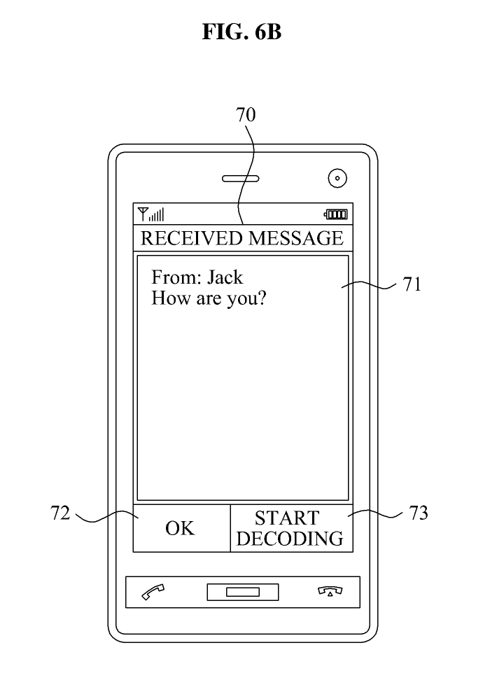

The message display unit 235 may display the decoded message. In this instance, the message display unit 235 may provide a screen (for example, a screen 60 of FIG. 6A) for displaying the decoded message.

FIG. 6A and FIG. 6B illustrate examples of a screen provided by a message display unit of FIG. 3. Referring to FIG. 6A, the screen 60 shows the decoded message displayed by the message display unit 235.

In addition, if a message reception of the reception processing unit 231 is generated, the message display unit 235 may further provide a screen (for example, a screen 70 of FIG. 6B) for displaying an encryption indication message. Referring to FIG. 6B, the screen 70 may include a region 71 in which the encryption indication message is displayed, an ‘OK’ button 72, and a ‘START DECODING’ button 73.

In this instance, the encryption indication message displayed in the region 71 may be one of a message input by a user or a sender, a picture, and a general message included in the encryption message to represent that an encrypted message has been received.

Also, the ‘START DECODING’ button 73 may be implemented by an event occurrence of a specific key without being directly displayed on the screen 70.

Also, the message display unit 235 may display only a general message of the received message, and insert an agreed upon code (for example, inserting ‘#’ at an end portion of the general message) designated by a user, so that other users cannot determine whether a message is encrypted.

Referring back to FIG. 1, the RF unit 300 may be controlled by the control unit 200, and convert a signal outputted from the control unit 200 into a radio signal. Also, the RF unit 300 may convert a radio signal received via an antenna into a suitable signal and output the converted signal.

The display unit 400 may be a display apparatus, such as a liquid crystal display apparatus, inorganic or organic light emitting diode display apparatus, and the like, and may display a screen of a mobile communication terminal, a general status screen, and the like through a control of the control unit 200.

The key input unit 500 may include a plurality of number keys and a plurality of function keys for performing various functions, and output key data to the control unit 200 by an external manipulation. Further, the key input unit 500 may be embodied as a touch screen of the display unit 400.

The near field communication unit 600 may provide a near field wireless communication (Bluetooth®, infrared communication, and the like) to be performed in conjunction with electronic devices existing in the vicinity of the terminal and another party's terminal.

In particular, the near field communication unit 600 may transmit, to the other party's terminal, first encryption information of the memory 100 in response to the encryption s information management unit 210, and receive, from the other party's terminal, arbitrary second encryption information, and a phone number of the other party. An information exchange described above may be implemented in another communication module as well as a near field wireless communication module, for example, over a wireless network or through wires.

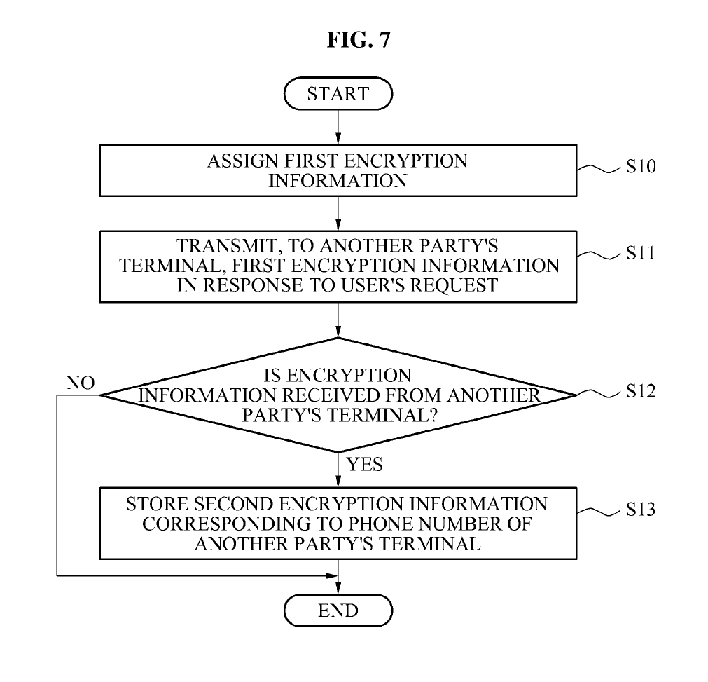

FIG. 7 illustrates an operation of an encryption information management unit of FIG. 1. Referring to FIG. 7, in operation S10, the encryption information management unit 210 may assign arbitrary first encryption information and store the assigned first encryption information in the memory 100.

In operation S11, the encryption information management unit 210 may transmit, to another party's terminal designated in response to a user's request, the first encryption is information stored in the memory 100. In this instance, the encryption information management unit 210 may enable a data transmission and data reception to/from the other party's terminal using the near field communication unit 600.

When receiving arbitrary second encryption information from the other party's terminal in operation S12, the encryption information management unit 210 may store the received second encryption information in the memory 100 to enable the received second encryption information to correspond to a phone number of the other party's terminal in operation S13.

Accordingly, each of the terminal and the other party's terminal may transmit one's own first encryption information to the other party's terminal, and receive the first encryption information of the other party's terminal to store the received first encryption information as second encryption information.

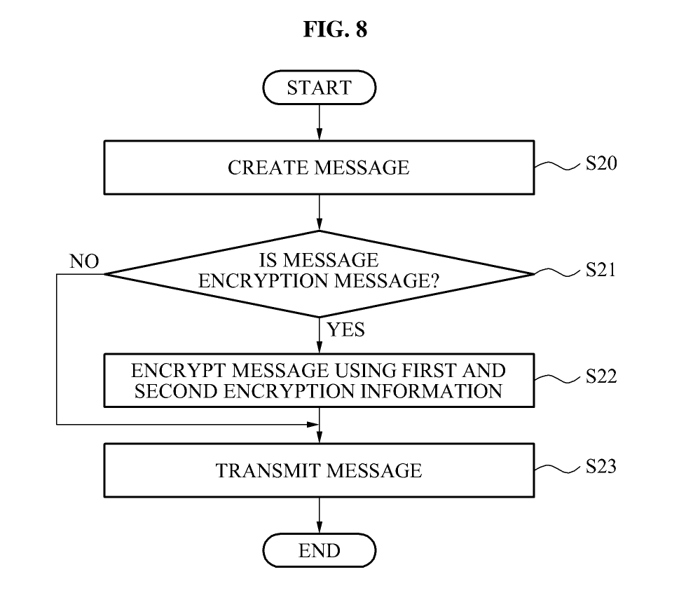

FIG. 8 illustrates an operation of a message transmission processing unit of FIG. 3. Referring to FIG. 8, in operation S20, the message creation unit 221 may create a message in response to a user's request and/or input.

In operation S21, the first determination unit 222 may determine whether the message created in operation S20 is encrypted or is to be encrypted. In operation S22, if the message is determined as the encryption message based on the determined result of operation S21, the encryption processing unit 223 may encrypt the message using the first encryption information 12 stored in the memory 100 and the second encryption information 14 corresponding to a reception phone number of the message.

In operation S23, the transmission processing unit 224 may transmit the message encrypted in operation 22 or the message not encrypted to the reception phone number corresponding to the message.

Accordingly, the terminal 10 may encrypt the original message 11 using the first encryption information 12 and the second encryption information 14, and transmit the encrypted message to the other party's terminal.

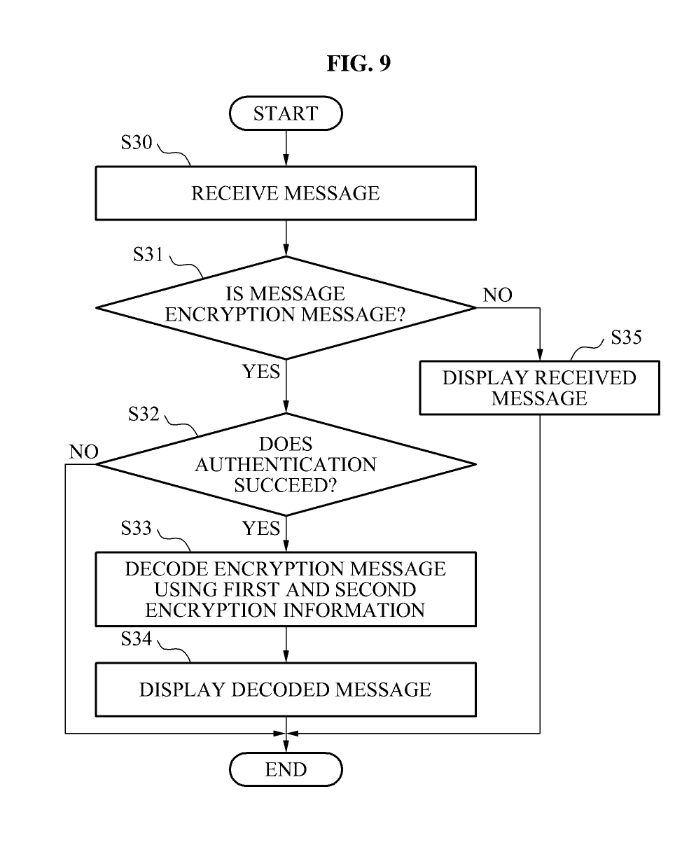

FIG. 9 illustrates an operation of a message reception processing unit of FIG. 3. Referring to FIG. 9, in operation S30, the reception processing unit 231 may receive a message.

In operation S31, the second determination unit 232 may determine whether the received message is an encryption message.

In operation S32, if the received message is determined as the encryption message based on the determined result of operation S31, the authentication processing unit 233 may perform a series of authentication processes with respect to a user (for example, inputting a social security number for authentication, etc.) to determine whether the authentication process succeeds.

In operation S33, if the authentication process succeeds based on the determined result of operation S32, the decoding processing unit 234 may decode the encryption message using the first encryption information 22 and the second encryption information 24 corresponding to a transmission phone number of the encryption message.

In operation S34, the message display unit 235 may display the message decoded in the operation S33.

In operation S35, if the received message is determined to not be the encryption message based on the determined result of operation S31, the message display unit 235 may display the received message.

Accordingly, the other party's terminal 20 may decode the received encryption message 21 using the first encryption information 22 and the second encryption information 24 to thereby display the decoded message 25.

An encryption code may be differentially applied for each terminal, so that the encryption key may not be leaked using an existing duplication scheme of a mobile phone. As a result, even though an illegally duplicated mobile phone receives an encryption message, the encryption message may not be decrypted.

Also, different encryption schemes may be used for each terminal so that an encryption message may not be decoded due to different encryption keys or the different encryption schemes even though an illegally duplicated mobile phone or another mobile phone intercepts the encryption message.

Also, a specific server used for encrypting a message may be unneeded, so that a message encryption function may be provided using a development of a manufacture regardless of a communication server and communication companies.

In particular, an encrypted message may be transmitted together with a general message so that an encryption method may be difficult to be detected, thereby reducing the risk of the message being decoded even though a copy of the message exists in a communication server.

The method for reading data according to the above-described exemplary embodiments may be recorded in computer-readable media including program commands to implement various operations embodied by a computer. The media may also include, alone or in combination with the program commands, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program commands, such as read-only memory (ROM), random access memory (RAM), flash memory, and the like, and combinations thereof. Examples of program commands include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a memory to store first encryption information applied to the terminal and second encryption information corresponding to a phone number of a second terminal; and
a control unit to encrypt a message using the first encryption information and the second encryption information stored in the memory, and to transmit the encrypted message to the second terminal.

2. The terminal of claim 1, wherein the first encryption information is applied in a manufacturing process of the terminal, or applied from a server when driving or booting the terminal.

3. The terminal of claim 1, wherein the first encryption information comprises an encryption key for encrypting the message or information indicating an encryption method.

4. The terminal of claim 1, wherein the second encryption information of the terminal is identical to first encryption information of the second terminal.

5. The terminal of claim 4, wherein the second encryption information of the terminal is the first encryption information of the second terminal received from a specific server or the second terminal.

6. The terminal of claim 1, wherein the control unit includes:
a message creation unit to create the message;
a first determination unit to determine whether the message created by the message creation unit is to be encrypted;
an encryption processing unit to encrypt the created message using the second encryption information corresponding to a reception phone number of the message and the first encryption information; and
a transmission processing unit to transmit the encrypted message.

7. The terminal of claim 1, wherein the control unit decodes a received encrypted message from the second terminal using the second encryption information corresponding to the phone number of the second terminal and the first encryption information.

8. The terminal of claim 1, wherein the control unit includes:
a second determination unit to determine whether a received message is an encrypted message;
a decoding processing unit to decode the received message using the first encryption information and the second encryption information corresponding to an originating phone number of the received message; and
a message display unit to display the decoded message.

9. The terminal of claim 8, wherein the control unit further includes an authentication processing unit to perform an authentication process and to request the decoding of the received message depending on whether the authentication process is successful.

10. The terminal of claim 8, wherein the message display unit displays on a screen an encryption indication message or picture, and displays the decoded message in accordance with an authenticated result of the authentication processing unit.

11. A method for processing an encrypted message of a terminal, the method comprising:
generating first encryption information of the terminal;
storing, as second encryption information, encryption information received from a second terminal, the second encryption information corresponding to a phone number of the second terminal;
encrypting a message using the first encryption information and the second encryption information; and
transmitting the encrypted message to the second terminal.

12. The method of claim 11, wherein the second encryption information of the terminal is first encryption information of the second terminal.

13. The method of claim of 11, wherein the first encryption information is applied in a manufacturing process of the terminal, or applied from a server when driving or booting the terminal.

14. The method of claim 11, wherein the first encryption information comprises an encryption key for encrypting the message or information indicating an encryption method.

15. The method of claim 11, wherein the storing comprises receiving, from the second terminal or a specific terminal, the first encryption information of the second terminal to store the received first encryption information.

16. The method of claim 11, wherein all or a portion of the message is encrypted.

17. A method for processing an encrypted message of a terminal, the method comprising:
generating first encryption information of the terminal;
storing, as second encryption information, encryption information received from a second terminal, the second encryption information corresponding to a phone number of the second terminal;
receiving a message from the second terminal;
determining whether the received message is an encrypted message;
decoding the received message using the first encryption information and the second encryption information; and
displaying the decoded message.

18. The method of claim 17, wherein the second encryption information of the terminal is identical to first encryption information of the second terminal.

19. The method of claim 17, wherein each of the first encryption information and the second encryption information comprises an encryption key for encrypting the message or information indicating an encryption method.

20. The method of claim 17, further comprising:
performing an authentication process, and requesting the decoding of the received message depending on whether the authentication process is successful.

21. The method of claim 17, further comprising:
displaying an encryption indication message or picture.
